(19) United States
(12) Patent Application Publication
(10) Pub. No.: US 2026/0302408 A1
(43) Pub. Date: Oct. 1, 2026

(54) THERMAL CONTROL IN BATTERY ENERGY STORAGE SYSTEMS

(71) Applicant: Fluence Energy, LLC, Arllington, VA (US)

(72) Inventor: Benjamin Joseph Braun, Berlin (DE)

(73) Assignee: Fluence Energy, LLC, Arllington, VA (US)

(21) Appl. No.: 19/633,940

(22) Filed: Mar. 30, 2026

Related U.S. Application Data
(60) Provisional application No. 63/781,481, filed on Apr. 1, 2025.

(51) Int. Cl. H01M 10/633; H01M 10/613; H01M 10/627

(52) U.S. Cl. CPC H01M 10/633; H01M 10/613; H01M 10/627; H01M 2220/10

(57) ABSTRACT

A system and a method for cooling a battery energy storage system (BESS). A cooling manager includes a parameter generator and a controller. The parameter generator is configured to generate operating parameters for a group of rechargeable batteries in a battery plant. The controller is configured to send control data to control a cooling unit to cool the group of rechargeable batteries based on the operating parameters and according to a thermal management policy.

### CROSS-REFERENCE TO RELATED APPLICATIONS

The present application claims the benefit of priority to U.S. Provisional Application No. 63/781,481 filed on Apr. 1, 2025, which is hereby incorporated by reference in its entirety.

### TECHNICAL FIELD

The disclosure generally relates to battery energy storage systems (BESS). More particularly, the subject matter disclosed herein relates to thermal control for BESS.

### BACKGROUND

Battery energy storage systems (BESS) are rechargeable batteries that store energy from a variety of energy sources (e.g., solar, wind) and release power into electrical grid to deliver electricity for distribution to consumers or other grid services. BESS have been integrated with renewable energy sources and increasingly played an important role for both residential and non-residential users. However, the expanding market for BESS is challenged by several problems. One important problem is that the electrochemical energy storage is vulnerable to overheating. When batteries are overheated, there may be several harmful consequences such as cell rupture, release of flammable and toxic gases, and fire and explosion. Factors that are responsible for overheating include overcharging, battery misuse, manufacturer defects, and short circuits. In addition, other environmental conditions may render the BESS ineffective. For example, when the ambient temperature is low or below some predetermined range or when there is a period without auxiliary power, the equipment or system may become cold and may need to be swiftly heated to an acceptable temperature before returning to operation.

There are several techniques to reduce risks of battery overheating or overcooling. One popular technique is to use an efficient thermal management system such as cooling. There are typically three ways for cooling BESS. They are air cooling, liquid cooling, and phase change cooling. Existing techniques for cooling, however, have a number of drawbacks. Chiller or cooling controls focus mainly on the temperature at the batteries as the triggering source of cooling. This often leads to an overdesign with high site costs.

### SUMMARY

To overcome these issues, a system and a method for cooling a battery energy storage system (BESS) is disclosed. The technique considers other factors such as external market, weather, operational modes, nighttime noise limits, and other environmental conditions. The technique uses a feed-forward strategy integrated with real-time feedback data. A cooling manager includes a parameter generator and a controller. The parameter generator is configured to generate operating parameters for a group of rechargeable batteries in a battery plant. The controller is configured to send control data to control a cooling unit to cool the group of rechargeable batteries based on the operating parameters and according to a thermal management policy.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram illustrating a system according to an embodiment.

FIG. 2 is a diagram illustrating a thermal manager according to an embodiment.

FIG. 3 is a diagram illustrating a parameter generator according to an embodiment.

FIG. 4 is a diagram illustrating a controller according to an embodiment.

FIG. 5 is a flowchart illustrating a process of thermal management according to an embodiment.

FIG. 6 is a flowchart illustrating a process of generating operating parameters according to an embodiment.

FIG. 7 is a flowchart illustrating a process of sending control data according to an embodiment.

FIG. 8 is a diagram illustrating a processing system according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

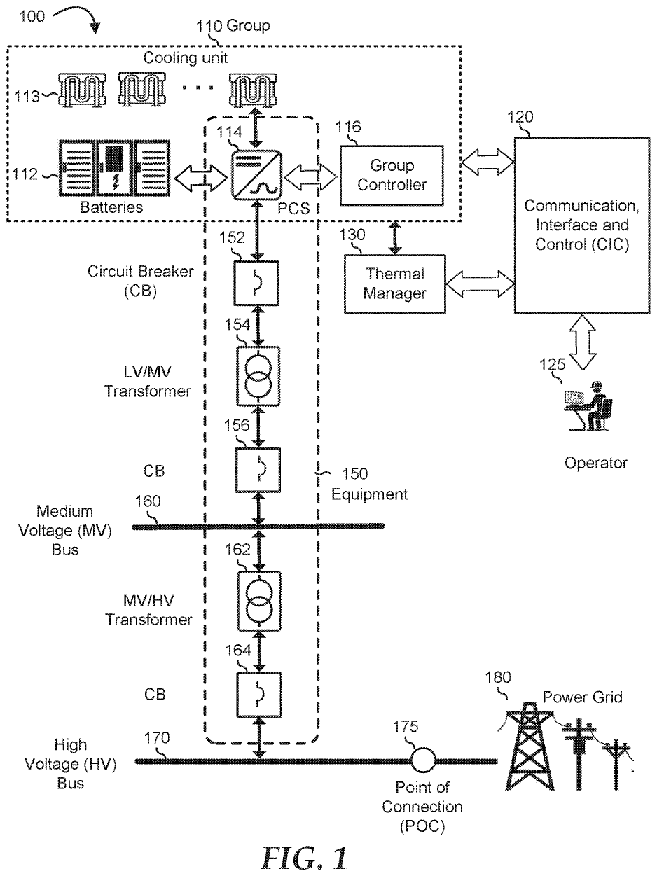

FIG. 1 is a block diagram illustrating a system 100 according to an embodiment. The system 100 may be referred to as a battery plant or a power plant. It includes a group 110, a communication, interface, and control (CIC) 120, a thermal manager 130, a first circuit breaker (CB) 152, an LV/MV transformer 154, a second CB 156, an MV/HV transformer 162, a third CB 164, and a point of connection (POC) 175. The system 100 may include more than these components.

The group 110 represents components in a group of a multi-level hierarchical structure. It includes a Battery Energy Storage Systems (BESS). The batteries in the BESS are often divided into groups for ease of management. For example, suppose the number of all batteries or battery modules in the BESS is N. These N batteries form an array of N batteries. The array may be divided in m groups, each having N/m batteries. Each of these may be referred to as a core. Each core may be further divided into smaller groups to form nodes. Each node may be formed by cubes and so on. For clarity and brevity, the term “group” refers to any of these levels. The group 110 includes a set of batteries 112, a cooling unit 113, a power conversion system (PCS) 114, and a group controller 116. The batteries 112 are rechargeable batteries. The types of batteries may include lithium-ion and lead-acid, but lithium-ion is the most popular type. The cooling unit 113 provides cooling to the batteries 112 and the PCS 114. It may include any type of cooling technology including liquid and air. For liquid cooling, it typically includes tubes that carry liquid coolant through the racks that house the batteries 112 and or the PCS 114. The PCS 114 converts the direct current (DC) to alternating current (AC) for use at the POC 175. When the batteries 112 need DC power, the PCS 114 may convers AC from an AC source to DC to the batteries. The group controller 116 performs control functions to elements in the group 110. In particular, it controls the cooling unit 113 to trigger a cooling action.

The CIC 120 provides communication, interface, and control to various parts and components in the system 100. The communication uses communication protocols to allow exchange information among various components in the system 100. Examples of the protocols are Modbus Transmission Control Protocol (TCP), Distributed Network Protocol 3 (DNP3), and International Electrotechnical Commission (IEC) 104. The control may include data acquisition, sensing operations, and monitoring. Examples include Supervisory Control and Data Acquisition (SCADA) systems which use networks, computers, and human-machine interfaces (HMIs) to gather and analyze data in real time. The CIC 120 also provides interfaces to various components and devices in the system 110, including a user interface to an operator 125. The operator 125 may be a professional operating and maintaining the CIC 120 and the thermal manager 130. The operator 125 may be or represent an expert in thermal control for power plant and rule-based system who may create rules and incorporate knowledge or facts in a rule-based system.

The thermal manager 130 performs thermal management for the batteries 112. In one embodiment, it provides cooling to the system using a feed-forward strategy. The first CB 152 acts to connect the PCS 114 to other equipment and to isolate the PCS 114 from the other equipment. The LV/MV transformer 154 steps up a low voltage (LV) at the LV side at the first CB 152 to a medium voltage (MV) at the MV side at the second CB 156. It may also step down the MV at the second CB 156 to a LV at the first CB 152. The second CB 156 connects the LV/MV transformer 154 to an MV bus 160. The MV/HV transformer 162 steps up the MV at the MV side at the MV bus 160 to a high voltage (HV) at the HV side at the third CB 164. When it is used in a bidirectional mode, the MV/HV transformer 162 may also step down the HV at the third CB 164 to the MV at the MV bus 160. The POC 175 is the point of connection to a power grid 180. It may also be the connection point from another energy source.

The PCS 114, the first CB 152, the LV/MV transformer 154, the second CB 156, the MV/HV transformer 162 and the CB 164 form equipment 150. The equipment 150 have internal losses along the way from the batteries 112 to the POC 175. Because of these losses, the output power of the batteries 112 is reduced at the POC 175.

### Exemplary Scenarios for Thermal Control in BESS

The system 100 shown in FIG. 1 represents a typical environment for a BESS power plant. The system 100 is designed to handle many scenarios for thermal control. The following are four exemplary scenarios. It should be noted that these scenarios are for illustrative purposes. Other scenarios are possible.

Self-Supply: The concept of self-supply is to use the BESS as its own uninterruptible power supply (UPS). One example of this self-supply mode is the black start scenario. A black start is a scenario in which there is a blackout or a partial shutdown on the grid power. When this happens, it is important to have a black start procedure which restores electric service for customers located in areas where blackout takes place. To do so, the BESS needs to provide power to individual power generators in an incremental manner until all power generators are reconnected and the entire system is restored. The process may take several hours and therefore may require constant power generation at the BESS. During this time, it is important to devote all or most resources to the restoring process to meet marketing demands and customers'requirements. Thermal management or cooling may become secondary. Power normally used for thermal management may be temporarily diverted to the black start process. Since black start is an infrequent event, the potentially harmful effects of overheated batteries due to lack of cooling may not be severe.

Power demands: Demands for power are not constant and therefore the BESS does not operate in a constant mode. Accordingly, thermal control will also be variable accordingly. One example of such a power demand is energy arbitrage where energy is bought and sold to maximize profits. The typical strategy is to buy low and sell high. The price fluctuates and depends on the demands. Often, the time periods for low and high-power demands are not aways predictable precisely. In addition, there are cases when the power demands are not known in advance such as abnormal weather conditions. Nevertheless, energy is often sold on a fixed time period basis, such as 15 minutes, 2 hours, depending on market conditions, geographical regions, and weather conditions. This piece of information may be helpful in devising a thermal management strategy. For example, if an arbitrage command is to deliver 10 MW for 30 minutes, then it may be useful to continue applying cooling to the BESS for the entire 30 minutes instead of toggling the thermal control according to the instantaneous coolant or battery temperatures as reported by the measurement and monitoring unit (e.g., the CIC 120).

Future knowledge: Power generation may be influenced by several external parameters related to future events. These parameters may not be contemporarily available or measurable but may be known in advance and therefore may be exploited as future knowledge to prepare the BESS for the upcoming event. Examples of the future knowledge include ambient temperature forecast, inter-plant dispatch, and scheduled operation. Thermal control strategy may utilize the future knowledge to plan ahead. For example, a weather forecast indicates that a heat wave condition may occur in the next three hours. Based on this forecast, the controller may issue a command to cool the batteries 112 in advance without waiting for the heat wave to actually arrive. By feedforwarding the control data based on future or predicted conditions, the thermal control avoids sudden control operations that may cause stress to the batteries.

Thermal balancing: Individual packs in a container may have several battery cells operating at different conditions while sharing the same bus. For example, a battery pack may have 56 battery cells. As the cell temperature increases, its internal impedance decreases. For an approximately constant voltage, the voltage-current-impedance relation (V=IR) will lead to an increase in current which may further increase the temperature and the process may continue. The result is that in a pack, there may be some batteries having constant currents and some having increasing currents. This will lead to unbalanced electrical load which may cause undesirable consequences. Accordingly, an objective of thermal control is to maintain a thermal equilibrium in the battery packs by providing appropriate cooling to the pack that exhibits unbalanced behavior. Depending on the thermal management policy, a hot battery that exhibits current higher than other batteries in a pack may be cooled more aggressively than usual. In some cases, this aggressive cooling may also be balanced by heating the otherwise normal batteries so that the currents of these normal batteries will match the hot batteries. The objective is to maintain balanced load, either in terms of equal temperatures or equal currents among the batteries in the same pack.

The above four scenarios illustrate the dynamic and multi-faceted nature of thermal control of BESS. A good thermal control strategy therefore should be versatile enough to accommodate a variety of scenarios including those that are not known at the present time. In addition, the above scenarios describe situations that need cooling, but as mentioned above, the concepts and techniques described in the following may also be applicable for scenarios where heating may be needed. The main objective is to maintain thermal equilibrium whether by cooling or by heating.

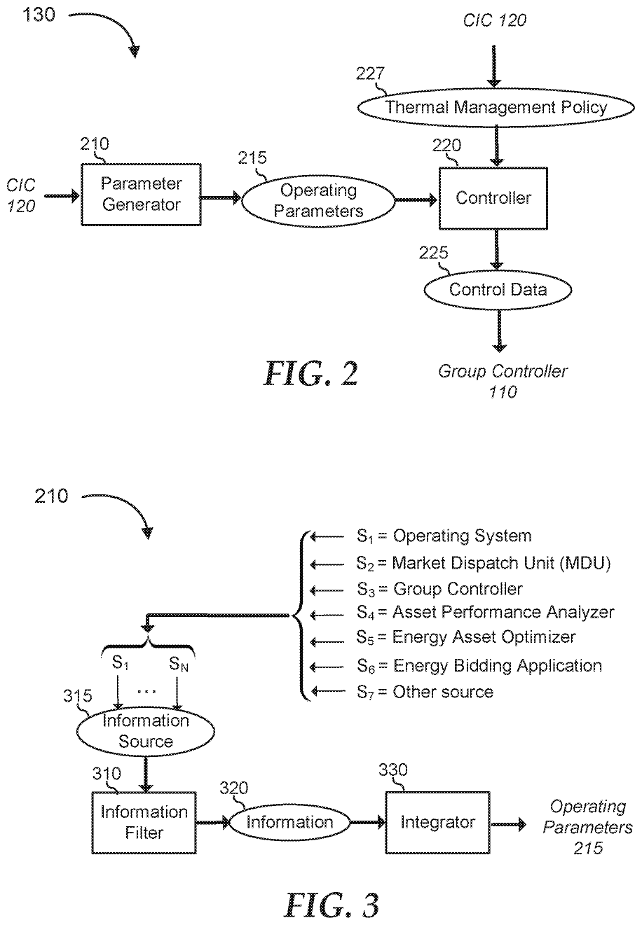

FIG. 2 is a diagram illustrating the thermal manager 130 shown in FIG. 1 according to an embodiment. The thermal manager 130 includes a parameter generator 210 and a thermal controller 220. The thermal manager 130 may include more or less than the above components.

The parameter generator 210 is configured to generate operating parameters 215 related to the batteries 112. The operating parameters 215 include data or information of the environment in which the batteries 112 are operating. This environment includes any factors that contribute to the heat generation at the batteries 112 at a current or future time. The parameter generator 210 performs its function by receiving information from the CIC 120. The TMP 227 includes policy or guidelines to manage the thermal conditions at the batteries 112. This policy may be provided by an administrator of the plant or as part of a general policy of an authority. The thermal management policy may include any policy, rules, or guidelines in thermal control. For example, a black start policy may include percentage of power resources for cooling being diverted for power generation during black start procedure, an arbitrage policy may include a power setpoint for a predetermined period, a future knowledge policy may include a temperature setpoint during a predetermined period (e.g., nighttime), a thermal equilibrium policy may include the threshold values to start or stop aggressive cooling, The thermal controller 220 is configured to send control data 225 to control the cooling unit 113 to cool the batteries 112 and the PCS 114 based on the operating parameters 215 and according to a thermal management policy (TMP) 227. The control data 225 may include temperature setpoint, cooling activation and/or actuation, power setpoint, and other commands or control data to corresponding units for thermal control. The thermal controller 220 may be integrated into the group controller 116. In some embodiments, the thermal controller 220 is configured to collect, organize, format, and transmit the control data while the group controller 116 performs the actual control functions (e.g., sending commands to actuators) based on the control data.

FIG. 3 is a diagram illustrating the parameter generator 210 shown in FIG. 2 according to an embodiment. The parameter generator 210 includes an information filter 310 and an integrator 330.

The information filter 310 is configured to receive information from the information source 315 and filter the received data or information to provide information 320. The information is related to the operating parameters 215 from N information sources 315 S₁ to S_{N} where N is a positive integer. At least one of the information sources is one of S₁ to S_{N}. The following are illustrative examples of the information sources:
S₁=an operating system (OS) of the battery plant. The OS performs a variety of monitoring, scheduling, and control tasks including collecting system limits such as cell, battery management system (BMS) and power conversion system (PCS) voltage, temperature, state of charge (SOC), state of health (SOH), and humidity; and scheduling market dispatch applications with all relevant timing and parameters.
S₂=a market dispatch unit (MDU). The MDU may be a part of the OS. The MDU monitors frequency points and determines if power should be added or removed from the grid. The MDU may dispatch real and reactive power to the group controller.
S₃=a group controller. The group controller provides dispatch signals to the batteries including discharge and charge commands and provide communication signals.
S₄=an asset performance analyzer (APA). The APA collects and analyzes data from various sources including the CIC 120, weather data, and grid conditions. The information may include identified trends, detected anomalies, and predicted potential issues.
S₅=an energy asset optimizer (EAO). The EAO analyzes data from various energy assets like solar panels, wind turbines, and energy storage systems to optimize their performance.
S₆=an energy bidding application (EBA). The EBA calculates the optimal bids for market products, considering price forecasts, operational constraints, and business objectives. The information may include price forecasting and price optimization and may be useful for arbitrage considerations and data.
S₇=Other application or source, including the SCADA data and information such as cell temperatures, cooling system temperatures, level of charge and discharge.

The information filter 310 gathers the data and information from the information sources S₁, . . . , S_{N} and filter the information to retain information that is relevant to the thermal control. Since the information sources 315 may include information that is not geared specifically to thermal control, or information that is scattered, it is necessary to filter the received information. This may include sorting out related data, resolving conflicting information, removing redundant or irrelevant data, prioritizing information, and formatting the information or data for subsequent processing. For example, supposed a maintenance operation is scheduled on a particular time period T and the information source 315 includes an alert of a blackout around the time period T. Since black start has a higher priority than maintenance, the maintenance operation is suppressed, and the black start information is forwarded so that the black start procedure can start.

The pieces of information 320 include at least one of a power set-point, a scheduled operation (e.g., black start), a battery operating parameter (e.g., temperature, current), a lifetime monitoring data, a degradation monitoring data, an ambient temperature, an energy price, a site noise limit, operational parameters of a cooling unit (e.g. coolant temperatures, compressor speed, fan speed, heater power), an operation mode of the battery plant, a weather condition, a near-term market data, a long-term asset lifetime, an arbitrage command. These pieces of information 320 individually may not be directly related to power or heat generated from the batteries, but together, they may provide clues and when combined, they may form a valid control data.

The integrator 330 is configured to integrate the multiple pieces of information 320 to generate the operating parameters 215. The integration may produce one or more aspects of the operating parameters 215 that may be useful in inferring the control data. In one embodiment, the integrator 330 may integrate the information according to some specified priority, or combine or merge data that are complementary according to a predefined approach. For example, suppose the coolant temperature in the operating parameters 215 shows a coolant temperature within the range but the battery temperature in the operating parameters 215 shows a battery temperature to be abnormally high. The coolant temperature and the battery temperature are complementary in that they are both related to the battery pack, but the coolant mainly reflects a local aspect of the temperature while the battery temperature reflects a more global aspect. The integrator 330 will integrate these data based on, say, a conservative approach, and use the abnormal temperature of the battery as the basis for determining the target temperature. As another example, suppose there are three future events: a scheduled maintenance operation, an ambient temperature forecast, and an arbitrage command. Suppose these events occur at the same time or overlap in time. The integrator 330 will apply a priority scheme which sets the priority in the order of arbitrage, forecast, and maintenance. Therefore, the scheduled maintenance operation and the ambient temperature forecast will be suppressed, and the arbitrage time period will be enforced. In some embodiments, a part of the integration process may be imported to the controller.

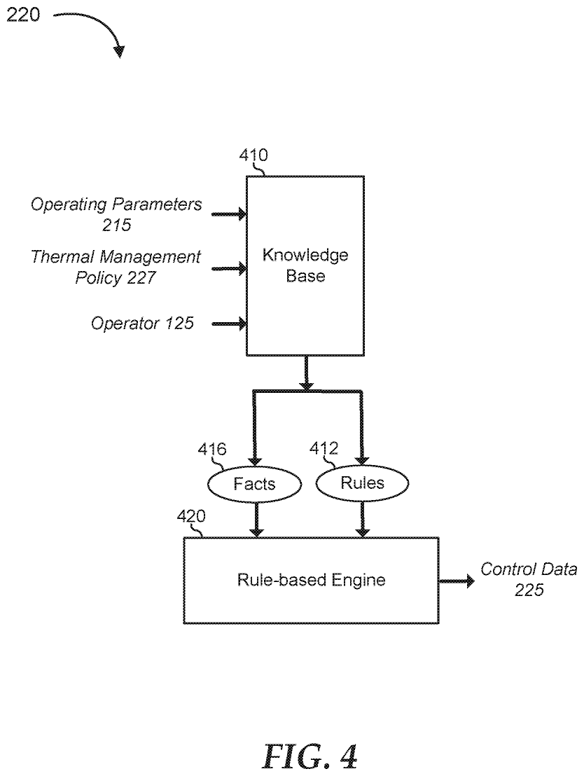

FIG. 4 is a diagram illustrating the controller 220 shown in FIG. 2 according to an embodiment. The controller 220 includes a knowledge base 410 and a rule-based engine 420. The controller 220 may include more or less than the above components. The controller 220 may be organized in any other form but the main process is to apply a rule in the form of a condition and an action. This process may be formally organized as a rule-based system, a machine learning (ML) system, or an application containing heuristic algorithms that perform a decision based on a set of conditions. The control strategy is an integrated hybrid approach based on feedforward and feedback paths. Examples of information for the feedforward path include scheduled operations, arbitrage commands, time of use, and weather prediction. This information is related to future events. Examples of information for the feedback path include battery temperatures, coolant temperatures, coolant flowrate, battery currents, level of charge, and level of discharge. This information is related to current conditions or events.

The knowledge base 410 is configured to store rules 412 and facts 416 related to mapping the operating parameters 215 to the control data 225. The operator 125 administers the knowledge base 410 including formulating the rules based on the thermal management policy. In one embodiment, the operator 125 may represent an expert or authority to establish the thermal management policy. The rules 412 and facts 416 include the thermal management policy 227. The operating parameters 215 carry static information (e.g., future knowledge) and dynamic or real-time information which will be used to trigger the corresponding rules. For example, the operating parameters 215 may include an arbitrage command with a specified time period. The arbitrage command may be asserted to indicate that arbitrage power should be activated for the specified period or de-asserted to indicate that arbitrage period is over. The knowledge base 410 applies the operating parameters 215 to the set of rules and the rules corresponding to the arbitrage will be triggered and actions will be performed accordingly. As another example, the operating parameters 215 may include battery conditions (e.g., temperature, current). The knowledge base 410 applies the battery conditions together with a thermal rule from the thermal management policy 227. This may trigger the rules for thermal equilibrium.

The knowledge base 410 may be updated when new knowledge becomes available. This may include new facts and new rules. Facts and rules may be revised when necessary. The operator 125 may be responsible for updating or revising the facts and rules in the knowledge base 410.

The rule-based engine 420 is configured to apply the rules 412 and facts 416 to infer the control data 225. The rules are in the form “IF condition THEN action” which establishes that if the condition is satisfied, then the action is performed. One example of a rule is to trigger cooling when the thermal management policy allows activating cooling independently of a triggering temperature threshold. Another example is to trigger cooling in a predetermined period after a start of a high-power operation. This rule may be relevant when it is expected the high-power operation will eventually cause the batteries 112 to generate heat. In this scenario, the rule states that it is better to activate cooling before the temperature actually rises. Another example is to trigger cooling according to a cyclic pattern. The rules apply the operating parameters 215 that may involve real-time data such as real-time measurements of battery temperatures, currents, or voltages; or real-time measurements of cooling system temperatures, condenser speed, pump flow rate, fan RPM, ambient temperature; or non-real-time data such as scheduled operation, ambient temperature forecast, weather conditions prediction.

Depending on the circumstances, the rule-based engine 420 may use a forward chaining strategy that starts with known facts or backward chaining strategy that works backwards from a desired goal.

The following is an example of a forward chaining reasoning used in the controller 220. Suppose there are two rules:
Rule 1: IF ((demand requires high power) AND (scheduled operation lasts more than 10 hours) ) THEN (triggering cooling is LIKELY)
Rule 2: IF ((triggering cooling is LIKELY) AND (weather is warm) ) THEN (trigger cooling 2 minutes after power is dispatched). In the above example, suppose all conditions in Rule 1 are met, then Rule 1 fires and a new fact “triggering cooling is LIKELY” is asserted. This new fact leads to Rule 2 and if the weather is warm, then Rule 2 fires and cooling is triggered 2 minutes after power is dispatched.

In general, the rules are developed according to the scenarios. For example, for the above four scenarios, there are at least a rule related to one of a self-supply scenario, a black start scenario, an arbitrage scenario, a future knowledge scenario, and a thermal equilibrium scenario. The following are examples of rules that may be used for the exemplary scenarios discussed above. It should be noted that these examples are mainly illustrative. The exact rules or values depend on the thermal management policy.

### Black Start Scenario:

Rule 3: IF ((Black-Start is ON) THEN (Stop Cooling Power) )
Rule 4: IF ((Black-Start changes from ON to OFF) AND (Battery Temperature>Upper Limit) THEN (Enable Cooling))

Rule 3 states that if a black start is declared, then the system stops using power for cooling so that power can be devoted for black start procedure. Rule 4 states that if the black start condition is over, i.e., the power has been completely restored, then the cooling process is enabled. In other words, power used for cooling can be started. Rules 3 and 4 are related to a black start scenario.

### Arbitrage Scenario:

Rule 5: IF (Arbitrage command is ON for a T period) THEN (Pause cooling for T period during arbitrage).
Rule 6: IF (Arbitrage command is OFF) THEN (Enable normal cooling)

Rule 5 states that when the arbitrage command is asserted for a period of T minutes, then the cooling is stopped temporarily for T minutes during arbitrage to reduce the auxiliary energy during a period of high energy prices. Rule 6 states that when the arbitrage command is de-asserted, indicating that the arbitrage period is over, then the cooling is enabled as normal.

### Future Knowledge Scenario:

Rule 7: IF ((Forecast ambient temperature at future time T>ambient hot threshold) AND (current time is equal to or less than two hours prior to T)) THEN (Start cooling at target temperature now)
Rule 8: IF ((Forecast ambient temperature at future time T<ambient cold threshold) AND (current time is equal to or less than two hours prior to T)) THEN (Start heating at target temperature now).

Rule 7 states that if the forecast ambient temperature is greater than a predetermined hot threshold and the current time is two hours or less than the forecast time, then start cooling now. Rule 7 may be an example of a predicted heat wave. Rule 8 states that if the forecast ambient temperature is less than a predetermined cold threshold and the current time is two hours or less than the forecast time, then start heating now. Rule 8 may be an example of a coming cold storm. Rules 7 and 9 are illustrative of using feedforward path for thermal control.

### Thermal or Current Equilibrium Scenario:

Rule 9: IF ((Temperature or Current of Battery A—Temperature or Current of Battery B)>Upper Threshold) THEN (Increase cooling Battery A)). A similar rule can be developed with the roles of Batteries A and B being reversed.
Rule 10: IF (ABS (Temperature or Current of Battery A—Temperature or Current of Battery B)<Lower Threshold) THEN (Return to Normal Cooling) )

Rule 9 states that if the temperature or current of battery A (or B) is greater than the temperature or current of Battery B (or A) by an amount of an upper threshold, then increase cooling Battery A (or B). This is to achieve thermal equilibrium. Rule 10 states that if the temperatures or currents of batteries A and B are approximately the same, i.e., they differ by some small amount of a lower threshold, then return to the normal cooling condition. The ABS function is the absolute function. The control operation may be either to cool or to heat one battery according to the thermal condition. This is done when thermal equilibrium has been achieved. Rules 9 and 10 are related to the thermal equilibrium scenario.

Other rules may be established according to the thermal management policy 227. As an example, suppose a thermal policy is to select global data over local data when global data are in conflict with local data. A chiller typically operates based on local conditions which may include temperatures and flow rates of the coolant that circulates in and out of a particular battery cell or pack (or PCS). A battery management system (BMS) typically has global measurements such as temperature of the entire set of batteries. When the coolant temperature indicates a normal condition and the BMS indicates a higher-than-normal temperature, a rule that is based on a conservative thermal policy may use the global temperature as the basis to set the target parameter or parameters. Other parameters may include flow rate, chiller compressor power/speed, fan speed, heater power, or any parameters that may have effects on the thermal conditions of the power plant. The inverse scenario may be used as the basis to adapt the heating operation.

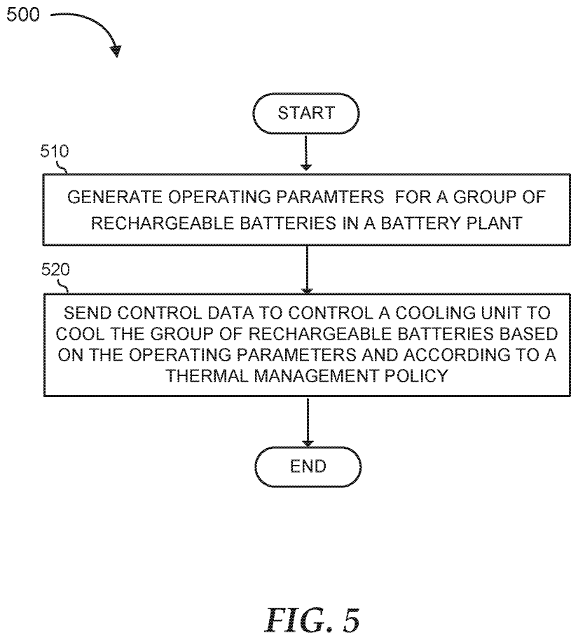

FIG. 5 is a flowchart illustrating a process 500 of thermal management according to an embodiment. Upon START, the process 500 generates operating parameters for a group of rechargeable batteries in a battery plant (Block 510). The operating parameters may include real-time monitoring data or measurements such as battery temperatures and currents, and non-real-time data such as scheduled operation, ambient temperature forecast. Next, the process 500 sends control data to control a cooling unit to cool the group of rechargeable batteries based on the operating parameters and according to a thermal management policy (Block 520). The cooling unit may employ any type of cooling technology such as liquid cooling and air cooling. The process 500 is then terminated.

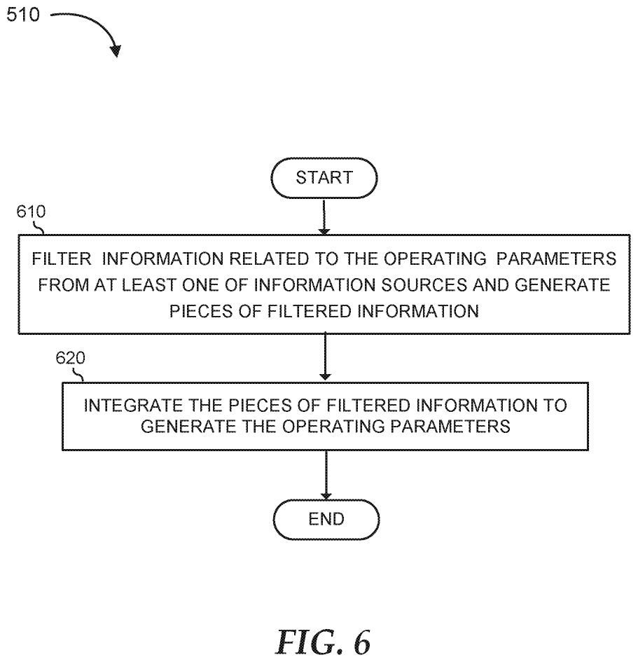

FIG. 6 is a flowchart illustrating a process 510 of generating operating parameters shown in FIG. 5 according to an embodiment.

Upon START, the process 510 filters the pieces of information related to the operating parameters and generates pieces of filtered information. The received information is from at least one of an information source including an operating system (OS) of the battery plant, a market dispatch unit (MDU), a controller, an asset performance analyzer, an energy asset optimizer, an energy bidding application, and an information application or functionality (Block 610). The information application or functionality may be any other applications, programs, devices, or units that provide information related to the operating parameters.

Next, the process 510 integrates the multiple pieces of filtered information to generate the operating parameters (Block 620). The process 510 is then terminated.

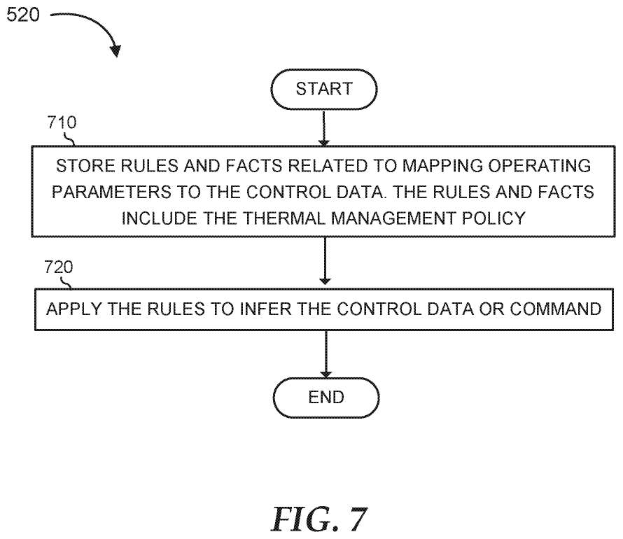

FIG. 7 is a flowchart illustrating the process 520 of sending control data shown in FIG. 5 according to an embodiment.

Upon START, the process 520 stores rules and facts related to mapping operating parameters to the control data (Block 710). The rules and facts include real-time and non-real-time data and the thermal management policy. The thermal management policy may include at least one of a black start policy, an arbitrage policy, a future knowledge policy, and a thermal equilibrium policy as discussed above. Next, the process 520 applies the rules to infer the control data (Block 720). The control data or command may include setting target temperatures, setting target power, or activating an operation, The process 520 is then terminated.

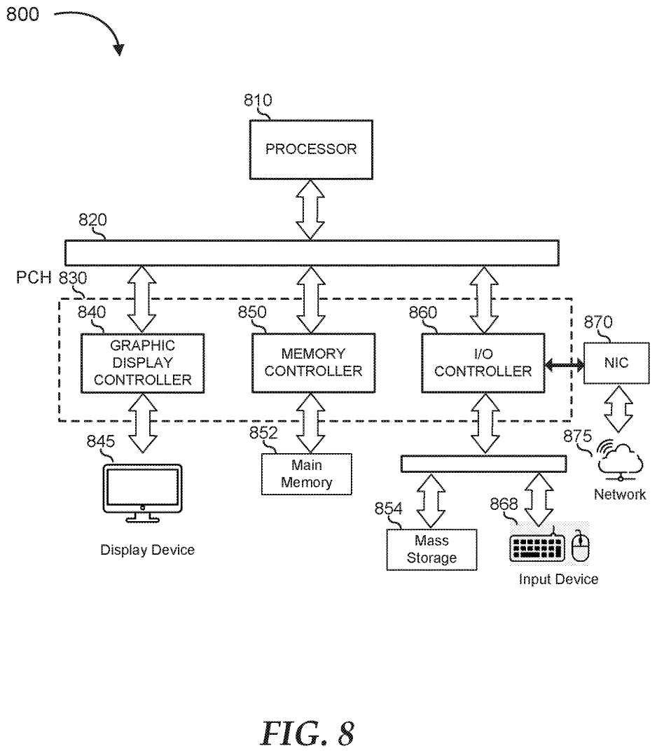

FIG. 8 is a diagram illustrating a processing or computing system 800 according to an embodiment.

The processing system or computing system 800 may be a host in a system on which the thermal manager 130 operates. It includes a central processing unit (CPU) or a processor 810, a platform controller hub (PCH) 830, and a bus 820. The PCH 830 may include a graphic display controller (GDC) 840, a memory controller 850, and an input/output (I/O) controller 860. The processing system 800 may include more or less than the above components. In addition, a component may be integrated into another component. As shown in FIG. 8, all the controllers 840, 850, and 860 are integrated in the PCH 830. The integration may be partial and/or overlapped. For example, the GDC 840 may be integrated into the processor 810, the I/O controller 860 and the memory controller 850 may be integrated into one single controller, etc.

The processor 810 is a programmable device that may execute a program or a collection of instructions to carry out a task. It may be a general-purpose processor, a digital signal processor, a microcontroller, or a specially designed processor such as one design from Applications Specific Integrated Circuit (ASIC). It may include a single core or multiple cores. Each core may have multi-way multi-threading. The processor 810 may have simultaneous multithreading feature to further exploit the parallelism due to multiple threads across the multiple cores. In addition, the processor 810 may have internal caches at multiple levels.

The bus 820 may be any suitable bus connecting the processor 810 to other devices, including the PCH 830. For example, the bus 820 may be a Direct Media Interface (DMI).

The PCH 830 in a highly integrated chipset that includes many functionalities to provide interface to several devices such as memory devices, input/output devices, storage devices, network devices, etc.

The I/O controller 860 controls input devices 868 (e.g., stylus, keyboard, and mouse, microphone, image sensor) and output devices (e.g., audio devices, speaker, scanner, printer), and a mass storage 854. The mass storage 854 may also include CD-ROM, hard disk, and solid-state drives (SSDs). It also has a network interface card (NIC) 870 which provides interface to a network and wireless medium 875.

The memory controller 850 controls memory devices such as a main memory 852. The main memory 852 includes random access memory (RAM) and/or the read-only memory (ROM) and other types of memory such as the cache memory or an SSD. The main memory 852 may store instructions or programs, loaded from a mass storage device, that, when executed by the processor 810, cause the processor 810 to perform operations as described above. It may also store data used in the operations. The ROM may include instructions, programs, constants, or data that are maintained whether it is powered or not. The instructions or programs may correspond to the functionalities described above, such as the parameter generator 210 or the controller 220.

The GDC 840 controls a display device 845 and provides graphical operations. It may be integrated inside the processor 810. It typically has a graphical user interface (GUI) to allow interactions with a user who may send a command or activate a function.

Additional devices or bus interfaces may be available for interconnections and/or expansion. The bus interfaces may be serial or parallel, with or without power delivery, etc.

The technique described in this disclosure has several advantages compared to existing techniques. First, it incorporates information from several sources to produce a reliable and comprehensive result. Second, the use of a rule-based engine allows expandability and ease in updating. Third, it avoids overdesign and reduces costs.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. An apparatus comprising:
a parameter generator configured to generate operating parameters for a group of rechargeable batteries in a battery plant; and
a controller configured to send control data to control a cooling unit to cool the group of rechargeable batteries based on the operating parameters and according to a thermal management policy.

2. The apparatus of claim 1, wherein the parameter generator comprises:
an information filter configured to receive and filter pieces of information related to the operating parameters from at least one of an information source including an operating system (OS) of the battery plant, a market dispatch unit, a controller, an asset performance analyzer, an energy asset optimizer, an energy bidding application, and an information application or functionality; and
an integrator configured to integrate the multiple pieces of filtered information to generate the operating parameters.

3. The apparatus of claim 1, wherein the controller comprises:
a knowledge base configured to store rules and facts related to mapping the operating parameters to the control data; and
a rule-based engine configured to apply the rules to infer the control data,
wherein the rules and facts include at least the thermal management policy.

4. The apparatus of claim 1, wherein the pieces of information include at least one of a power set-point, a scheduled operation, a battery operating parameter, a lifetime monitoring data, a degradation monitoring data, an ambient temperature, an energy price, a site noise limit, an operation mode of the battery plant, a weather condition, a near-term market data, a long-term asset lifetime, or an arbitrage command.

5. The apparatus of claim 2, wherein the OS performs operations including collecting data at the battery plant for continuous monitoring and alerting.

6. The apparatus of claim 2, wherein the asset performance analyzer provides analysis information including identified trends, detected anomalies, and predicted potential issues.

7. The apparatus of claim 2, wherein the energy bidding application provides market information including price forecasting and price optimization.

8. The apparatus of claim 3, wherein the rules include at least a forward-chaining rule and a backward-chaining rule.

9. The apparatus of claim 3, wherein the rules include at least one of a self-supply scenario, a black start scenario, an arbitrage scenario, a future knowledge scenario, or a thermal equilibrium scenario.

10. The apparatus of claim 1, wherein the thermal management policy includes at least one of a black start policy, an arbitrage policy, a future knowledge policy, or a thermal equilibrium policy.

11. A method comprising:
generating operating parameters for a group of rechargeable batteries in a battery plant; and
sending control data to control a cooling unit to cool the group of rechargeable batteries based on the operating parameters and according to a thermal management policy.

12. The method of claim 11, wherein generating operating parameters comprises:
receiving and filtering pieces of information related to the operating parameters from at least one of an information source including an operating system (OS) of the battery plant, a market dispatch unit, a controller, an asset performance analyzer, an energy asset optimizer, an energy bidding application, and an information application or functionality; and
integrating the multiple pieces of filtered information to generate the operating parameters.

13. The method of claim 11, wherein sending control data comprises:
storing rules and facts related to mapping operating parameters to the control data; and
applying the rules to infer the control data,
wherein the rules and facts include at least the thermal management policy.

14. The method of claim 12, wherein the pieces of information include at least one of a power set-point, a scheduled operation, a battery operating parameter, a lifetime monitoring data, a degradation monitoring data, an ambient temperature, an energy price, a site noise limit, an operation mode of the battery plant, a weather condition, a near-term market data, a long-term asset lifetime, or an arbitrage command.

15. The method of claim 12, wherein the OS performs operations including collecting data at the battery plant for continuous monitoring and alerting.

16. The method of claim 12, wherein the asset performance analyzer provides analysis information including identified trends, detected anomalies, and predicted potential issues.

17. The method of claim 12, wherein the energy bidding application provides market information including price forecasting and price optimization.

18. The method of claim 13, wherein the rules include at least a forward-chaining rule and a backward-chaining rule.

19. The method of claim 13, wherein the rules include at least one of a self-supply scenario, a black start scenario, an arbitrage scenario, a future knowledge scenario, and a thermal equilibrium scenario.

20. A battery energy storage system (BESS) comprising:
a cooling unit configured to cool at least one of a group of rechargeable batteries or a power conversion system in a battery plant; and
a thermal manager configured to control the cooling unit, comprising:
a parameter generator configured to generate operating parameters for the group of rechargeable batteries; and
a controller configured to send control data to control the cooling unit to cool the group of rechargeable batteries based on the operating parameters and according to a thermal management policy.
